(19) United States
(12) Patent Application Publication
(10) Pub. No.: US 2011/0021408 A1
(43) Pub. Date: Jan. 27, 2011

(54) COMPOSITIONS CONTAINING BENEFIT AGENT DELIVERY PARTICLES

(76) Inventors: Michelle Meek, Tyne and Wear (GB); Phillip Frank Souter, Northumberland (GB); Susana Fernandez Prieto, Benicarlo (ES); Johan Smets, Lubbeek (BE); Mohan Gopalkrishna Kulkarni, Pune (IN); Parshuram Gajanan Shukla, Pune (IN); Aruna Narayan Bote, Pune (IN); Arun Savalaram Jadhav, Pune (IN)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/832,396

(22) Filed: Jul. 8, 2010

Related U.S. Application Data
(60) Provisional application No. 61/224,492, filed on Jul. 10, 2009.

(51) Int. Cl. C11D 3/22; C11D 17/00; C11D 3/40; C11D 3/386

(52) U.S. Cl. 510/321; 510/418; 510/400; 510/337; 510/393

(57) ABSTRACT

The present disclosure relates to benefit agent delivery particles containing at least one benefit agent and at least one cellulosic polymer. The disclosure further relates to compositions containing benefit agent delivery particles and processes for making and using such compositions. The disclosure further relates to methods of imparting a benefit delivery capability to a cleaning composition.

### CROSS REFERENCE TO RELATED APPLICATIONS

This application claims priority to U.S. Provisional Application Ser. No. 61/224,492, filed Jul. 10, 2009.

### FIELD OF INVENTION

The present disclosure relates to benefit agent delivery particles, compositions comprising such benefit agent delivery particles, and processes for making and using such benefit agent delivery particles and compositions.

### BACKGROUND OF THE INVENTION

Benefit agents, such as enzymes, hueing dyes, perfumes, perfume delivery compositions, bleaching agents, chelating agents, and polymers, are expensive and can be difficult to formulate, particularly into cleaning compositions, due to their incompatibility with other ingredients. Further, because such cleaning compositions must often be stored for long periods of time, the overall cleaning, care and/or sensorial performance of the cleaning composition may be compromised as a result of formulation degradation during storage due to the interaction of benefit agents with other formulation ingredients.

As benefit agents tend to be expensive, there is a desire to maximize their effectiveness and maintain formulation stability. Benefit agent effectiveness may be improved by segregating the product's benefit agent from other product ingredients, for example by encapsulating the benefit agent. Segregation may impart many benefits, including improved product stability during storage, enhanced benefit delivery, and/or delivery of a benefit using lower levels of benefit agent. This provides the formulator and consumer with a sustainability advantage as material resources are used more effectively. Unfortunately, capsules comprising a benefit agent may not release the benefit agent at the right rate or time as their benefit release mechanisms, including diffusion and/or capsule rupture rate, may be variable.

Thus, there is a need for compositions wherein incompatible benefit agents can be stored without the detrimental effect of degradation of one or more ingredients during storage. There is a further need for compositions wherein the benefit agent can be stably stored within the composition but which can be effectively released in use. The disclosed encapsulation systems and/or compositions minimize or eliminate one or more of the aforementioned drawbacks.

### SUMMARY OF THE INVENTION

The present disclosure relates to benefit agent delivery particles, compositions comprising such benefit agent delivery particles, and processes for making and using such benefit agent delivery particles and compositions. Such compositions may comprise liquid compositions such as liquid detergents.

According to one embodiment, the present disclosure provides a cleaning composition comprising (a) a benefit agent delivery particle comprising a benefit agent and a cellulosic polymer selected from the group consisting of hydroxypropyl methylcellulose phthalate, cellulose acetate phthalate, and mixtures thereof; and (b) one or more adjunct ingredients selected from the group consisting of dye transfer inhibiting agents, brighteners, bleaching agents, photobleaches, clay soil removal/anti-redeposition agents, soil release polymers, soil suspension polymers, suds suppressors, perfumes, fabric softeners, hueing agents, chelating agents, and combinations thereof, wherein the cleaning composition is a liquid.

According to another embodiment, the present disclosure provides a method of imparting a benefit delivery capability to a fabric cleaning composition comprising combining a particle comprising a benefit agent and a polymer selected from the group consisting of hydroxypropyl methyl cellulose phthalate, cellulose acetate phthalate, and mixtures thereof with the cleaning composition.

According to a further embodiment, the present disclosure provides an article comprising a cleaning composition according to the various embodiments described herein and a water soluble film.

According to still another embodiment the present disclosure provides a method of cleaning and/or treating a situs comprising the steps of (a) optionally rinsing and/or washing the situs, (b) contacting the situs with the cleaning composition according to the various embodiments described herein, and (c) optionally washing and/or rinsing the situs.

### DETAILED DESCRIPTION OF THE INVENTION

### Definitions

As used herein, the phrase “benefit agent delivery particle” is intended to refer to encapsulates and/or microcapsules and/or aggregates and/or particles comprising one or more benefit agents and one or more cellulosic polymer as described herein.

As used herein, the term “cleaning composition” includes, unless otherwise indicated, liquid, gel, paste, granule, or powder-form washing and/or cleaning agents, including the so-called heavy-duty liquid types; liquid fine-fabric detergents; hand dishwashing agents or light duty dishwashing agents, including those of the high-foaming type; machine dishwashing agents, including the various liquid and rinse-aid types for household and institutional use; liquid cleaning and disinfecting agents, including antibacterial hand-wash types, mouthwashes, denture cleaners, dentifrice, car or carpet shampoos, bathroom cleaners; hair shampoos and hair-rinses; shower gels and foam baths and metal cleaners; as well as cleaning auxiliaries such as bleach additives and “stain-stick” or pre-treat types; substrate-laden products such as dryer added sheets, dry and wetted wipes and pads, nonwoven substrates, and sponges; and sprays and mists containing the aforementioned cleaning compositions.

As used herein, the articles such as “a” and “an” when used in a claim, are understood to mean one or more of what is claimed or described.

As used herein, the terms “include,” “includes,” and “including” are meant to be non-limiting.

As used herein, the term “liquid,” as applied to the compositions herein, is intended to refer to compositions having a viscosity of from about 20 centipoises to about 50,000 centipoises and includes liquid, gel and paste product forms.

As used herein, the term “situs” includes paper products, fabrics, garments, hard surfaces, hair and skin.

The test methods disclosed in the Test Methods Section of the present application should be used to determine the respective values of the parameters of Applicants' inventions.

Unless otherwise noted, the enzymes disclosed herein are expressed in terms of active protein level and are exclusive of impurities, for example, residual solvents or by-products, which may be present in commercially available sources.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Compositions

Cleaning compositions containing a benefit agent delivery particle are disclosed. Applicants have unexpectedly found that the disclosed compositions comprising a benefit agent delivery particle solve the problem of instability of benefit agents. Upon encountering the ionic conditions encountered when laundering fabrics, Applicants have surprisingly found that the benefit agent delivery particles of the disclosed compositions rupture and effectively release the benefit agent.

The benefit agent delivery particles of the disclosed compositions may comprise at least one cellulosic polymer selected from the group consisting of hydroxypropyl methylcellulose phthalate (HPMCP), cellulose acetate phthalate (CAP), and mixtures thereof, and a benefit agent. Such polymers include polymers that are commercially available under the trade names NF Hypromellose Phthalate (HPMCP) (Shin-Etsu), cellulose ester NF or cellulose cellacefate NF (CAP) from G.M. Chemie Pvt Ltd, Mumbai, 400705, India and Eastman Chemical Company, Kingsport, USA. The benefit agent may comprise a material selected from the group consisting of enzymes, hueing dyes, metal catalysts, bleach catalysts, peracids, perfumes, biopolymers, chelating agent, and mixtures thereof. The benefit provided by the benefit agent delivery particle may include whiteness and/or dingy cleaning, stain removal (such as grass, blood, or gravy), greasy stain removal, bleaching, longer lasting freshness, and fabric hueing.

In one aspect, the one or more benefit is an enzyme. The benefit agent may comprise hemicellulases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, oxidoreductases, dehydrogenases, xyloglucanases, amylases, cellulases, and mixtures thereof.

In one aspect, the enzyme may comprise a metalloprotease or a serine protease or a chymotrypsin-type, or a trypsin-type protease.

In one aspect, the enzyme may comprise a serine protease, including neutral or alkaline microbial serine proteases. In one aspect, said neutral or alkaline serine proteases may comprise subtilisins (EC 3.4.21.62) derived from Bacillus, such as Bacillus lentus, B. alkalophilus, B. subtilis, B. amyloliquefaciens, Bacillus pumilus and Bacillus gibsonii and genetically modified variants thereof possessing at least about 90%, at least about 95%, at least about 98%, or at least about 99%, or 100% identity with said neutral or alkaline serine proteases. As used herein, the degree of identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends in Genetics 16: 276-277; http://emboss.org), version 3.0.0 or later. The optional parameters used are gap open penalty of 10, gap extension penalty of 0.5, and the EBLOSUM62 (EMBOSS version of BLOSUM62) substitution matrix. The output of Needle labelled “longest identity” (obtained using the -nobrief option) is used as the percent identity and is calculated as follows:

(Identical Residues×100)/(Length of Alignment−Total Number of Gaps in Alignment)

In one aspect, the protease may be a variant of the subtilisin BPN′ wild-type enzyme derived from Bacillus amyloliquefaciens that contains the Y217L mutation. The subtilisin BPN′ wild-type enzyme sequence is the 275 amino acids (amino acids 108-382) of the Swissprot accession no. P00782 (derived from Bacillus amyloliquefaciens).

In one aspect, the enzyme may comprise a metalloprotease derived from Bacillus amyloliquefaciens and genetically modified variants thereof possessing at least about 90%, at least about 95%, at least about 98%, or at least about 99%, or 100% identity with said metalloprotease.

In one aspect, the enzyme may comprise an α-amylase. The α-amylase may comprise any from the EC classification 3.2.1.1. The α-amylase may comprise low temperature amylases, or chemically or genetically modified mutants (variants) of low temperature amylases include. Examples include alkaline amylases possessing at least about 90%, at least about 95%, at least about 98%, or at least about 99%, or 100% identity with those derived from Bacillus sp. NCIB 12289, NCIB 12512, NCIB 12513, DSM 9375 (U.S. Pat. No. 7,153,818) DSM 12368, DSMZ no. 12649, KSM AP1378 (US 2008/0050807 A1), KSM K36 or KSM K38 (US 2002/0197698 A1).

In one aspect, the enzyme may comprise a lipase having E.C. classification 3.1.1.3, as defined by EC classification, IUPAC-IUBMB and genetically modified variants thereof possessing at least about 90%, at least about 95%, at least about 98%, or at least about 99%, or 100% identity with said lipase. In one aspect, said lipase and variants thereof are derived from the wild-type Humicola Lanuginosa. In one aspect, the lipase may be a variant of the wild-type lipase from Thermomyces lanuginosus comprising the T231R and N233R mutations. The wild-type sequence is the 269 amino acids (amino acids 23-291) of the Swissprot accession number Swiss-Prot O59952 (derived from Thermomyces lanuginosus (Humicola lanuginosa)).

In one aspect the enzyme may comprise a xyloglucanase belonging to family 44 of glycosyl hydrolases.

In one aspect, the enzyme may comprise a cutinase as defined by E.C. Class 3.1.1.73. The enzyme may have at least about 90% or about 95%, or about 98% identity with a wild-type from one of Fusarium solani, Pseudomonas Mendocina or Humicola Insolens.

In a further aspect, the enzyme may comprise cellobiose dehydrogenase.

In one aspect, the benefit agent may comprise a bleach or bleach catalyst such as preformed peracids, bleach activators, catalytic metal complexes, non-metal bleach catalyst and mixtures thereof. In one aspect, preformed peracids include percarboxylic acids and salts, percarbonic acids and salts, perimidic acids and salts, peroxymonosulfuric acids and salts, (for example, Oxone®), and mixtures thereof.

In one aspect, the benefit agent may comprise a bleach booster such as 2-[3-[(2-hexyldodecyl)oxy]-2-(sulfooxy)propyl]-3,4-dihydroisoquinolinium, inner salt; 3,4-dihydro-2-[3-[(2-pentylundecyl)oxy]-2-(sulfooxy)propyl]isoquinolinium, inner salt; 2-[3-[(2-butyldecyl)oxy]-2-(sulfooxy)propyl]-3,4-dihydroisoquinolinium, inner salt; 3,4-dihydro-2-[3-(octadecyloxy)-2-(sulfooxy)propyl]isoquinolinium, inner salt; 2-[3-(hexadecyloxy)-2-(sulfooxy)propyl]-3,4-dihydroisoquinolinium, inner salt; 3,4-dihydro-2-[2-(sulfooxy)-3-(tetradecyloxy)propyl]isoquinolinium, inner salt; 2-[3-(dodecyloxy)-2-(sulfooxy)propyl]-3,4-dihydroisoquinolinium, inner salt; 2-[3-[(3-hexyldecyl)oxy]-2-(sulfooxy)propyl]-3,4-dihydroisoquinolinium, inner salt; 3,4-dihydro-2-[3-[(2-pentylnonyl)oxy]-2-(sulfooxy)propyl]isoquinolinium, inner salt; 3,4-dihydro-2-[3-[(2-propylheptyl)oxy]-2-(sulfooxy)propyl]isoquinolinium, inner salt; 2-[3-[(2-butyloctyl)oxy]-2-(sulfooxy)propyl]-3,4-dihydroisoquinolinium, inner salt; 2-[3-(decyloxy)-2-(sulfooxy)propyl]-3,4-dihydroisoquinolinium, inner salt; 3,4-dihydro-2-[3-(octyloxy)-2-(sulfooxy)propyl]isoquinolinium, inner salt; 2-[3-[(2-ethylhexyl)oxy]-2-(sulfooxy)propyl]-3,4-dihydroisoquinolinium, inner salt.

In one aspect, the benefit agent may comprise a diacyl, or alternatively, a diacyl clathrated, or alternatively a diacyl selected from the group consisting of dinonoyl peroxide, didecanoyl peroxide, diundecanoyl peroxide, dilauroyl peroxide, dibenzoyl peroxide, di-(3,5,5-trimethyl hexanoyl) peroxide and mixtures thereof.

In one aspect the benefit agent may comprise a catalytic metal complex. The transition-metal bleach catalyst may comprise, for example, manganese, iron and chromium. In one aspect, the ligand may comprise an ultra-rigid cross-bridged ligand such as 5,12-diethyl-1,5,8,12-tetraazabicyclo[6.6.2]hexa-decane. Suitable transition metal ligands are readily prepared by known procedures, for example, as taught in WO00/32601, and U.S. Pat. No. 6,225,464. Suitable non-metal bleach catalysts and appropriate levels of such catalysts are disclosed in U.S. Pat. No. 7,169,744 B2 and USPA 2006/0287210 A1. Suitable metal catalysts include dichloro-1,4-diethyl-1,4,8,11-tetraaazabicyclo[6.6.2]hexadecane manganese(II); dichloro-1,4-dimethyl-1,4,8,11-tetraaazabicyclo[6.6.2]hexadecane manganese(II), and mixtures thereof.

In one aspect, the benefit agent may comprise a perfume, a perfume delivery composition, or mixtures thereof. In one aspect, the benefit agent contains at least one perfume ingredient comprising a melamine formaldehyde polymer that encapsulates the at least one perfume ingredient.

In one aspect, the benefit agent may comprise a hueing dye such as those disclosed in USPA 2007/0129150 A1 and USPA 2008/0177089 A1, a dye, dye-clay conjugates, and/or pigments. Suitable hueing dyes include: (a) Small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, such as Direct Violet Colour Index (Society of Dyers and Colourists, Bradford, UK) numbers Direct Violet 9, Direct Violet 35, Direct Violet 48, Direct Violet 51, Direct Violet 66, Direct Blue 1, Direct Blue 71, Direct Blue 80, Direct Blue 279, Acid Red 17, Acid Red 73, Acid Red 88, Acid Red 150, Acid Violet 15, Acid Violet 17, Acid Violet 24, Acid Violet 43, Acid Violet 49, Acid Blue 15, Acid Blue 17, Acid Blue 25, Acid Blue 29, Acid Blue 40, Acid Blue 45, Acid Blue 75, Acid Blue 80, Acid Blue 83, Acid Blue 90 and Acid Blue 113, Acid Black 1, Basic Violet 1, Basic Violet 3, Basic Violet 4, Basic Violet 10, Basic Violet 35, Basic Blue 3, Basic Blue 16, Basic Blue 22, Basic Blue 47, Basic Blue 66, Basic Blue 75, Basic Blue 159, Acid Violet 17, Acid Violet 43, Acid Red 73, Acid Red 88, Acid Red 150, Acid Blue 25, Acid Blue 29, Acid Blue 45, Acid Blue 113, Acid Black 1, Direct Blue 1, Direct Blue 71 and Direct Violet 51. (b) Polymeric dyes include polymeric dyes selected from the group consisting of polymers containing conjugated chromogens (dye-polymer conjugates) and polymers with chromogens copolymerized into the backbone of the polymer and mixtures thereof such as fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® (Milliken, Spartanburg, S.C., USA) Violet CT, carboxymethyl cellulose (CMC) conjugated with a reactive blue, reactive violet or reactive red dye such as CMC conjugated with C.I. Reactive Blue 19, sold by Megazyme, Wicklow, Ireland under the product name AZO-CM-CELLULOSE, product code S-ACMC and mixtures thereof. (c) Dye clay conjugates include dye clay conjugates selected from the group comprising at least one cationic/basic dye and a smectite clay, and mixtures thereof. (d) Pigments such as Ultramarine Blue (C.I. Pigment Blue 29), Ultramarine Violet (C.I. Pigment Violet 15) and mixtures thereof.

In one aspect, the benefit agent may comprise a fabric softening active, a deposition agent, cationic polymer or cationic starch, or mixtures thereof, such as, for example, any of those described in USPA 2008/0131695.

In one aspect, the benefit agent may comprise a chelating agent active, such as, for example, diethylene triamine pentamethylene phosphonic acid (“DTPMP”), hydroxy-ethane diphosphonic acid (“HEDP”), diethylene triamine pentaacetic acid (“DTPA”) and mixtures thereof.

In one aspect, the benefit agent delivery particle may have a particle size of from about 0.1 microns to about 2000 microns, from about 0.2 microns to about 1000 microns, from about 0.3 microns to about 200 microns, or from about 0.5 microns to about 50 microns or about 0.5 to about 30 microns. The benefit agent delivery particle may be in the form of a microcapsule. In one aspect, the particles or microcapsules are sized such that they are not typically visible to a consumer when such microcapsules are incorporated into a cleaning composition. Without being bound by theory, it is believed that having a low particle size facilitates the liquid phase's ability to suspend the particles, thereby keeping the liquid phase as homogenous as possible.

In one aspect, liquid cleaning compositions that may contain more than one type of benefit agent delivery particle—for example, different types of particles having different release properties—are disclosed. In one aspect, the liquid cleaning composition may comprise a first benefit agent delivery particle capable of releasing a benefit agent in from about one second to about one minute, or from about one second to about two minutes or from about one second to three minutes, according to Test Method 1, and a second benefit agent capable of releasing a benefit agent within from about two minutes to about 10 minutes or within from about three minutes to about ten minutes or within from about 5 minutes to about 10 minutes according to Test Method 1. In one aspect, more than one benefit agents are supplied by the more than one benefit agent delivery particles. The benefit agent(s) may be present in the amount of from about 0.0001% to about 10%, from about 0.001% to about 4%, or from about 0.01% to about 2%, or from about 0.2% to about 1.5% by weight of the total cleaning composition.

In one aspect, the compositions contain a benefit agent delivery particle, wherein the benefit agent delivery particle releases from about 50% to about 100%, or from about 60% to about 100%, or from about 70% to about 100%, or from about 80% to about 100%, or from about 90% to about 100% of the benefit agent within a time period of from about one second to about 10 minutes, or from about one second to about five minutes, or from about one second to about two minutes, or from about one second to about one minute upon dilution in water as set out in Test Method 1. In one aspect, the benefit agent delivery particle releases from about 50% to about 100%, or from about 60% to about 100%, or from about 70% to about 100%, or from about 80% to about 100%, or from about 90% to about 100% of the benefit agent within about five minutes upon dilution in water as set out in Test Method 1.

In one aspect, the compositions contain a benefit agent delivery particle, wherein the benefit agent delivery particle contains from about 60% to about 100%, or from about 70% to about 100%, or from about 80% to about 100% or from about 90% to about 100% of the benefit agent after being stored at Warm Storage Conditions for 3 weeks (as set out in Test Method 2).

In one aspect, the composition may contain, based on total composition weight, from about 1% to about 90% water, from about 3% to about 60%, from about 4% to about 40%, from about 5% to about 25% or from about 5% to about 10% water. In one aspect, the compositions may contain from about 0.01% to about 80%, or from about 0.01% to about 70%, or from about 0.01% to about 60%, or from about 0.01% to about 50%, or from about 0.01% to about 40% water and/or other solvent. The composition may contain a benefit agent delivery particle, wherein the benefit agent delivery particle contains from about 0.5% to about 90%, or from about 1% to about 50%, or from about 2% to about 30%, or from about 5% to about 25%, or from about 10% to about 25% by dry weight of the benefit agent.

In one aspect, the disclosed compositions may have a viscosity of from about 20 cP to about 50,000 cP, or from about 50 cP to about 5,000 cP, or from about 60 cP to about 1,000 cP. The compositions may have a pH of from about 6 to about 11, from about 7 to about 10, or from about 7.5 to about 9. In one aspect, the compositions, absent the one or more benefit agent delivery particle, may have a specific density, expressed in g/cm³, of from about 1.0 to about 1.5, from about 1.01 to about 1.2, or about 1.02 to about 1.1.

In one aspect, the compositions may be characterized by the difference between the specific density of the benefit agent delivery particle and the specific density of the composition absent the benefit agent delivery particle. In this aspect, the difference, expressed in g/cm³, between the specific density of each type of benefit agent delivery particle and the specific density of the cleaning composition minus the one or more benefit agent delivery particles may be from about 0 to about 0.5, from 0 to about 0.2, from 0.00001 to about 0.05. The standard deviation for the density of each type of benefit agent delivery particles may be from about 0 to about 0.2, or from about 0.00001 to about 0.05.

### Adjunct Materials

In one aspect, the disclosed compositions contain a benefit agent delivery particle and one or more adjunct ingredients. The adjunct ingredient may comprise any of those described herein, or may comprise any other adjunct agent suitable for use in the desired composition. The non-limiting list of adjuncts illustrated hereinafter are suitable for use in the instant compositions and may be incorporated in certain aspects, for example to assist or enhance performance, for treatment of the substrate to be cleaned, or to modify the aesthetics of the composition. Such adjuncts may be in addition to the benefit delivery particles described above. The precise nature of these additional components, and levels of incorporation thereof, will depend on the physical form of the composition and the nature of the operation for which it is to be used. Suitable adjunct materials include surfactants, builders, chelating agents, dye transfer inhibiting agents, brighteners, dispersants, enzymes, and enzyme stabilizers. The adjunct may include catalytic materials, bleaching agents, photobleaches, non-metal bleach catalysts, polymeric dispersing agents, clay soil removal/anti-redeposition agents, soil release polymers and soil suspension polymers, brighteners, suds suppressors, dyes, perfumes, structure elasticizing agents, fabric softeners, carriers, hydrotropes, processing aids, solvents, pigments, hueing agents, and mixtures thereof. Examples of suitable adjuncts and levels of use are also found in, for example, U.S. Pat. Nos. 5,576,282, 6,306,812 B1 and 6,326,348 B1.

In one aspect, the structurant may be an external structuring system. The composition of the present invention preferably comprises from 0.01% to 5%, preferably from 0.1% to 1% by weight of an external structuring system. The external structuring system is preferably selected from the group consisting of: (i) non-polymeric crystalline, hydroxy-functional structurants and/or (ii) polymeric structurants.

Such external structuring systems are those which impart a sufficient yield stress or low shear viscosity to stabilize the fluid laundry detergent composition independently from, or extrinsic from, any structuring effect of the detersive surfactants of the composition. Preferably, they impart to the fluid laundry detergent composition a high shear viscosity at 20 s⁻¹ at 21° C. of from 1 to 1500 cP and a viscosity at low shear (0.05 s⁻¹ at 21° C.) of greater than 5000 cP. The viscosity is measured using an AR 550 rheometer from TA instruments using a plate steel spindle at 40 mm diameter and a gap size of 500 μm. The high shear viscosity at 20 s⁻¹ and low shear viscosity at 0.5 s⁻¹ can be obtained from a logarithmic shear rate sweep from 0.1 s⁻¹ to 25 s⁻¹ in 3 minutes time at 21° C.

Non-Polymeric Crystalline Hydroxyl-Functional Materials: In a preferred embodiment, the composition further comprises from 0.01% to 1% by weight of a non-polymeric crystalline, hydroxyl functional structurant. Such non-polymeric crystalline, hydroxyl functional structurants generally comprise a crystallizable glyceride which can be pre-emulsified to aid dispersion into the final unit dose laundry detergent composition. Preferred crystallizable glycerides include hydrogenated castor oil (“HCO”) or derivatives thereof, provided that it is capable of crystallizing in the liquid detergent composition. Other non-polymeric structurants include diglycerides, triglycerides, and ethylene glycol distearate and mixtures thereof.

Polymeric Structuring Agents: Laundry detergent compositions of the present invention may comprise from 0.01% to 5% by weight of a naturally derived and/or synthetic polymeric structurant. Examples of naturally derived polymeric structurants of use in the present invention include: microcrystalline cellulose, cellulose-based materials, microfiber cellulose, hydroxyethyl cellulose, hydrophobically modified hydroxyethyl cellulose, carboxymethyl cellulose, polysaccharide derivatives, biopolymers, and mixtures thereof. Suitable polysaccharide derivatives include: pectine, alginate, arabinogalactan (gum Arabic), carrageenan, gellan gum, xanthan gum, guar gum and mixtures thereof. Examples of synthetic polymeric structurants of use in the present invention include: polycarboxylates, polyacrylates, hydrophobically modified ethoxylated urethanes, hydrophobically modified non-ionic polyols and mixtures thereof. Preferably the polycarboxylate polymer is a polyacrylate, polymethacrylate or mixtures thereof. In another preferred embodiment, the polyacrylate is a copolymer of unsaturated mono- or di-carbonic acid and C1-C30 alkyl ester of the (meth)acrylic acid. Such copolymers are available from Noveon Inc. under the trade name Carbopol Aqua 30.

In a further aspect, the pH of the composition is between about 2 and about 11, or from about 3 to about 8.5 or from 3 to about 5. Without wishing to be bound by theory it is believed that lower pH drives better in-product stability. Various sensitive ingredients, such as enzymes, are not ordinarily stable in such matrices at the extremes of formulated pH (above 9 or below 6). The capsules of the current invention allow the formulator to deliver superior cleaning.

In one aspect, the adjunct may comprise an enzyme stabilizer selected from the group consisting of (a) inorganic salts selected from the group consisting of calcium salts, magnesium salts and mixtures thereof; (b) carbohydrates selected from the group consisting of oligosaccharides, polysaccharides and mixtures thereof; (c) mass efficient reversible protease inhibitors selected from the group consisting of phenyl boronic acid and derivatives thereof; and (d) mixtures thereof.

### Processes of Making Benefit Agent Delivery Particles and Compositions

Methods of making benefit agent delivery particles are also disclosed. The compositions may be formulated into any suitable form and prepared by any process chosen by the formulator, for example as disclosed in U.S. Pat. No. 4,990,280; USPA 2003/0087791 A1; USPA 2003/0087790 A1; USPA 2005/0003983 A1. In one aspect, the benefit agent delivery particles may be made using a spray drying process, comprising the steps of i) providing a cellulosic polymer and a benefit agent in a solvent to form a mixture, ii) introducing the mixture into a spray dryer for a period of time sufficient for the benefit agent delivery particles to form. The solvent may comprise an organic solvent, alkaline alcoholic solvent, alkaline aqueous solvent, aqueous solvent, or mixtures thereof. In one aspect, the solvent may comprise sodium bicarbonate. Mechanical action may be employed during the dissolving step. In one aspect, the cellulosic polymer may be dissolved in the solvent prior to the introduction of the benefit agent.

In one aspect, the process of making cellulosic polymer coated particles and/or agglomerates may comprise two (2) parts: a) combining and/or contacting a solution comprising a cellulosic polymer, including hydroxypropyl methylcellulose phthalate and cellulose acetate phthalate, and a solvent, including water and/or ethanol, with melamine-formaldehyde microcapsules comprising a benefit agent and/or a slurry comprising said melamine-formaldehyde microcapsules to form a cellulosic polymer/microcapsule slurry and b) collecting cellulosic polymer coated melamine formaldehyde microcapsules from said slurry. In one aspect, a cellulosic polymer solution is prepared and a slurry comprising melamine-formaldehyde microcapsules comprising a benefit agent, is added to said solution to form a slurry comprising cellulosic polymer and said melamine-formaldehyde microcapsules. In one aspect, when flow focusing is employed to collect the cellulosic polymer coated melamine formaldehyde microcapsules, the aforementioned slurry is contacted with a second cellulosic polymer solution that may comprise a cellulosic polymer including but not limited to, hydroxypropyl methylcellulose phthalate and cellulose acetate phthalate. In one aspect, a plasticizer may be added to the cellulosic polymer/melamine-formaldehyde microcapsule slurry to modify the properties of the resulting cellulosic polymer coated melamine formaldehyde microcapsules—for example to soften the cellulosic polymer coated microcapsules and/or improve the cellulosic polymer coated microcapsules' benefit agent's release during use. Suitable plasticizers include plasticizers selected from the group consisting of dibutyl sebacate, polyethylene glycol and polypropylene glycol, dibutyl phthalate, diethyl phthalate, triethyl citrate, tributyl citrate, acetylated monoglyceride, acetyl tributyl citrate, triacetin, dimethyl phthalate, hydroxypropyl methylcellulose, benzyl benzoate, butyl and/or glycol esters of fatty acids, refined mineral oils, oleic acid, castor oil, corn oil, camphor, glycerol, sorbic acid, sorbitol, shellac, polyvinyl alcohol and mixtures thereof. In one aspect, said plasticizer comprises glycerol. In one aspect, the cellulosic polymer and melamine-formaldehyde microcapsule slurry is combined with an organic material, for example an oil including but not limited to a vegetable oil such as soybean oil, to form a slurry comprising cellulosic polymer, melamine formaldehyde microcapsules and the organic material. In one aspect, a second solvent is added to the cellulosic polymer/melamine formaldehyde microcapsule slurry and the first solvent is evaporated which results in cellulosic polymer coated melamine formaldehyde microcapsules in the second solvent. In any of the aforementioned aspects of the invention, the aforementioned slurry may, as needed, be kept homogenous by continual mixing and/or the addition of a surfactant prior to drying. Suitable collecting techniques include, but are not limited to, spray drying, filtration, flow focusing, and combinations thereof.

In one aspect a process of making cellulosic polymer coated particles and/agglomerates may comprise the use of a fluidized bed, wherein a material selected from the group consisting of a benefit agent, a melamine formaldehyde encapsulated benefit agent, a cellulosic polymer coated a benefit agent and/or a cellulosic polymer coated melamine formaldehyde encapsulated benefit agent and mixtures thereof may be contacted with a second cellulosic polymer, that may comprise a cellulosic polymer including but not limited to, hydroxypropyl methylcellulose phthalate and cellulose acetate phthalate.

### Method of Imparting a Benefit Delivery Capability

A method of imparting a benefit delivery capability to a cleaning composition comprising combining a particle comprising a benefit agent and a polymer selected from the group consisting of hydroxypropyl methylcellulose phthalate, cellulose acetate phthalate, and mixtures thereof with a cleaning composition is also disclosed. In one aspect, said benefit agent may be selected from the group consisting of enzymes, hueing dyes, metal catalysts, bleach catalysts, peracids, perfumes, biopolymers, and mixtures thereof. In one aspect, said particle is combined with at least one component of said cleaning composition and said combination of particle and at least one component of said cleaning composition is combined with other materials to form a cleaning composition.

### Method of Use

A method for cleaning and/or treating a situs inter alia a surface or fabric is also disclosed. Such method includes the steps of optionally washing and/or rinsing a surface or fabric; contacting a composition disclosed herein (either in neat form or diluted in a wash liquor), with at least a portion of a surface or fabric, then optionally rinsing and/or washing such surface or fabric. The term “washing” includes scrubbing, and/or mechanical agitation. As will be appreciated by one skilled in the art, the disclosed compositions, in one aspect, are suited for use in laundry applications. Accordingly, a method for laundering a fabric is disclosed. In one aspect, the method includes the steps of contacting a fabric to be laundered with a composition disclosed herein. In one aspect, the final pH of the solution used for the wash or the rinse step may be from about 5 to about 8.5, from about 6 to about 8.4, or from about 6.5 to about 8.2. The compositions may be used at concentrations of from about 500 ppm to about 15,000 ppm in solution. The water temperatures typically range from about 5° C. to about 90° C. The water to fabric ratio may be from about 1:1 to about 30:1. In one aspect, the composition may be supplied in a water soluble pouch, wherein the pouch may comprise polyvinyl alcohol.

### Test Methods

Viscosity is determined using a viscometer (Model AR2000, available from TA Instruments, New Castle, Del., USA), each sample is tested at a sample temperature of 25° C. using a 40 mm 2° steel cone at shear rates between 0.01 and 150 s⁻¹. Viscosities are expressed as units centipoise (cps) and are measured at a shear rate of 1 s⁻¹.

Average Particle Size is determined in accordance ASTM E1037-84 version 1, 2004.

pH is assayed according to the standard method ES ISO 10523:2001 version 1.

Test Method 1—Benefit Agent Release from Benefit Agent Delivery Particle

0.05 g of benefit agent delivery particle is weighed and dispersed into 5 mL of the liquid detergent described in Example 16 The resulting mixture is then diluted into 500 mL of water (having the composition described in Table 1) at 20° C. The mixture is then stirred for 10 minutes at 150 RPM using a stirrer plate, IKAMAG RET basic, available from Scientific Lab.com.

The amount of benefit agent released after 1, 2, 5, and 10 minutes from the benefit agent delivery particle can be measured using standard analytical methods. Enzyme release may be measured using ASTM method D0348-89 (2003).

### Test Method 2—Determination of Benefit Agent Leakage and Stability on Storage

0.05 g benefit agent delivery particle is weighed and dispersed into 5 mL of the liquid detergent described in Example 16. The resulting mixture is then mixed for 2 minutes and sealed in a standard airtight 10 mL glass vial. This procedure is repeated, resulting in 20 multiple replicates. The 20 replicates are split equally into two batches. Ten replicates of Batch 1 are placed into a temperature controlled oven at 35° C. (Warm Storage Conditions) for a period of three weeks. Ten replicates of Batch 2 (Cold Storage Conditions) are placed into a refrigerator at 5° C. for a period of three weeks. The samples are removed from each of the two temperature controlled rooms after the three week period and analyzed for benefit agent content (note in the case of materials such as enzymes that can be inactivated, the resulting data is compared to analysis is versus the active content).

### Determining Benefit Agent Release and Leakage

Five replicates from each of Batch 1 and 2 (as described above) are individually diluted into 500 mL of water (having the composition described in Table 1) at 20° C. Each mixture is stirred for 10 minutes at 150 RPM using a stirrer plate, IKAMAG RET basic, available from ScientificLab.com. The mixtures are then analyzed using the protocol described in Test Method 1 to determine the total amount of benefit agent remaining after storage. This amount is expressed as A mg/mL of composition, where A is the value emerging from the test. Five replicates from each different batch are filtered through a 0.45 micron filter (available from Whatman Incorporated, N.J., USA) to remove the benefit agent delivery particles. Each filtered fluid sample is then individually diluted into 500 mL of water (having the composition described in Table 1) at 20° C. The diluted filtered fluid sample is then stirred for 10 minutes at 150 RPM using a stirrer plate, IKAMAG RET basic, available from Scientific Lab.com, and analyzed according to the protocol described in Test Method 1 to determine the amount of benefit agent that has leaked from the benefit agent delivery particle after storage. This amount is expressed as B mg/ml of composition, where B is the value emerging from the test.

The % benefit agent present after storage in the benefit agent particle (“X”) can be calculated using the following equation:

X=100(A−B)/C

wherein A and B are the values obtained as described above, and C is the amount of benefit agent expected to be present in the liquid detergent sample based on the activity of the added benefit agent delivery particle using standard analytical method such as those disclosed in Test Method 1.

### Example 1

### Synthesis of a Benefit Agent Delivery Particle Containing Amylase Enzyme Encapsulated in Hydroxypropylmethylcellulose Pthalate (HPMCP)

Two grams of HPMCP, grade 55 (Shin-Etsu, Chemical Co., Ltd, Tokyo 100-0004, Japan) is dissolved into 25 mL of alcoholic sodium hydroxide (0.52% weight/volume sodium hydroxide in methanol) is placed into a 100 mL conical flask and sonicated for 30 minutes. 5.2 g of Amylase liquid (available from Novozymes A/S having Amylase activity of 220 KNU/ml) is added to the homogenous solution and stirred for 10 minutes at 150 RPM using a stirrer plate, IKAMAG RET basic (available from ScientificLab.com). This dispersion is fed into the spray dryer (available from Buchi, B-191, Switzerland) at a rate of 2.5 mL/minute, using a constant atomized air pressure of 2 kg/cm². The inlet and outlet temperatures are 40° C. and 30° C. respectively. The dispersion feedstock is continuously stirred at 150 RPM using a stirrer plate (IKAMAG RET basic, available from ScientificLab.com) while being fed into the spray dryer (Buchi, B-191, Switzerland). The benefit agent delivery particles formed in the spray dryer are collected into a receptor vessel via a cyclone. The benefit agent delivery particles are then weighed (1.62 g) and measured for particle size in the range of from about 2 to about 15 microns in accordance to ASTM E1037-84 method, version 1. The resulting benefit agent delivery particles are analyzed by SEM (TM-1000, Hitachi), Axio Microscope (Zeiss, Germany) and STEREO microscope (Zeiss, Germany).

The benefit agent delivery particles are analyzed initially and after being stored for active enzyme content using Test Methods 1 and 2. The resultant particles have enzyme activity of 4%, or 40 mg/g active in each particle. The particles retain ≧80% active enzyme content (about 80-100%) and have a % leakage of from about 0% to about 5% as measured using Test Method 1. After applying warm storage conditions according to Test Method 2, (3 weeks at 35° C.) the benefit agent present after storage in the benefit particle is about 80% to 100%, while the % leakage is from 0-10%.

### Example 2

### Synthesis of a Benefit Agent Delivery Particle Containing Protease Enzyme Encapsulated in Cellulose Acetate Phthalate (CAP)

Five grams of CAP powder (G.M. Chemie Pvt Ltd, Mumbai, 400 705, India) is dissolved into 95 mL of aqueous sodium bicarbonate (1.26% weight/volume). This solution is then transferred into a glass petri dish which is then placed into glass container containing liquid nitrogen for five minutes or until the mixture attains the temperature of the liquid nitrogen. The petri dish is then freeze dried using a lyophilizer (Alpha 1-2 LD, from Martin Christ, Gefriertrocknungsanlagen GmbH, D-37507 Osterode am Harz, Germany) for 9.5 hours at −54° C. The resulting freeze-dried, alkali-treated CAP product forms a film which is cut into small pieces and then used for making the microcapsules. 2 g of the freeze-dried, alkali-treated CAP is dissolved into 33 mL of methanol, and placed into a 100 mL conical flask and sonicated for 30 minutes. 0.81 g of Savinase® liquid (supplied by Novozymes A/S having Protease activity of 44 KNPU/g) is added to the homogenous solution and stirred for 10 minutes at 150 RPM using a stirrer plate (IKAMAG RET basic, supplied by ScientificLab.com). The dispersion feedstock is continuously stirred at 150 RPM using a stirrer plate (IKAMAG RET basic, available from ScientificLab.com) while being fed into the spray dryer (Buchi, B-191, Switzerland) at a rate of 2.5 mL/minute, using a constant atomized air pressure of 2 kg/cm². The inlet and outlet temperatures are 40° C. and 30° C. respectively. The benefit agent delivery particles formed in the spray dryer are collected into a receptor vessel via a cyclone. The benefit agent delivery particles are then weighed (1.23 g) and measured for particle size distribution of about 2-15 microns in accordance to ASTM E1037-84 method, version 1. The resulting benefit agent delivery particles are analyzed by SEM (TM-1000, Hitachi), Axio Microscope (Zeiss, Germany) and STEREO microscope (Zeiss, Germany).

The benefit agent delivery particles are analyzed initially and after being stored for active enzyme content using Test Methods 1 and 2, described above.

### Example 3

### Synthesis of a Benefit Agent Delivery Particle Comprising a Hueing Dye

The process of Example 1 is used, except the enzyme benefit agent is a hueing dye as described above.

### Example 4

### Synthesis of a Benefit Agent Delivery Particle Comprising 20 Wt % Core/80 Wt % HPMCP Coated Dichloro-1,4-diethyl-1,4,8,11-tetraaazabicyclo[6.6.2]hexadecane manganese(II).

A 10% solution of HPMCP, grade 50 (“HP 50”) (available from SEPPIC SA, 7 Boulevard Franck Kupka, 92039 Paris La Defense, Cedex, France) in a 5% sodium bicarbonate aqueous solution is prepared at 50° C. and filtered with a 1.2 micron filter (Albet, Dassel, Germany). The solution is cooled to room temperature. Two grams of dichloro-1,4-diethyl-1,4,8,11-tetraaazabicyclo[6.6.2]hexadecane manganese(II) are added to 98 g of the HP 50 solution previously prepared and mixed (IKA RW-16-Basic, available from IKA-Werke GmbH & Co. KG, Janke & Kunkel Str. 10, 79219 Staufen, Germany) until the dichloro-1,4-diethyl-1,4,8,11-tetraaazabicyclo[6.6.2]hexadecane manganese(II) is completely dissolved. A spray-dryer is used to collect the particles (4M8 Spray-Dryer from ProCepT, Belgium). Parameters used in the spray-drying process are as follows: nozzle 0.4 mm; schuin 60 cyclone; temperature inlet air 140° C.; air flow 0.4 m³/min; feeding speed 2 mL/min with syringe. A yield of 58.14% is obtained. Particles are than collected and analyzed by SEM (TM-1000, Hitachi).

### Example 5

### Synthesis of a Benefit Agent Delivery Particle Comprising 20 Wt % Core/80 Wt % Wall HPMCP, Grade 50

A 10% solution of HPMCP, grade 50 (“HP 50”) (available from SEPPIC SA, 7 Boulevard Franck Kupka, 92039 Paris La Defense, Cedex, France) in a 5% sodium bicarbonate aqueous solution is prepared at 50° C. and filtered with a 1.2 micron filter (Albet, Dassel, Germany). The solution is cooled to room temperature. 4% Glycerol (Sigma Aldrich) is added as plasticizer. 2 g of dichloro-1,4-diethyl-1,4,8,11-tetraaazabicyclo[6.6.2]hexadecane manganese(II) are added to 98 g of the HP 50 solution previously prepared and mixed (using IKA RW-16-Basic, available from IKA-Werke GmbH & Co. KG, Janke & Kunkel Str. 10, 79219 Staufen, Germany) until the dichloro-1,4-diethyl-1,4,8,11-tetraaazabicyclo[6.6.2]hexadecane manganese (II) is completely dissolved. A spray-dryer is then used to collect the particles (4M8 Spray-Dryer from ProCepT, Belgium). Parameters used in the spray-drying process are as follows: nozzle 0.4 mm; schuin 60 cyclone; temperature inlet air 140° C.; air flow 0.4 m³/min; feeding speed 2 mL/min with syringe. A yield of 65.37% is obtained. Solid particles are collected and then analyzed by microscopy techniques: SEM (TM-1000, Hitachi), Axio Microscope (Zeiss, Germany) and STEREO microscope (Zeiss, Germany). The particles contain dichloro-1,4-diethyl-1,4,8,11-tetraaazabicyclo[6.6.2]hexadecane manganese(II) as the benefit agent.

### Example 6

### 90 wt % Core/10 Wt % HPMCP Coated Peractive AP in Liquid Laundry Composition

70 g of Peractive AP (TAED, Clariant, Frankfurt, Germany) is weighed and introduced into a fluid bed coater with wurster (4M8-Fluidbed, ProCepT, Belgium). Hot air is set up at 85° C. and 775 g of a solution of 10% HPMCP 50, previously prepared dissolving 100 g of HP 50 (available from SEPPIC SA, 7 Boulevard Franck Kupka, 92039 Paris La Defense, Cedex, France) in 900 g of an aqueous solution 5.5% sodium hydroxide, is sprayed from the bottom at a rate of 0.5 mL/min with an air speed of 0.4 m³/min. Material is collected and analyzed by SEM (TM-1000, Hitachi). The resulting coating is less than 100% uniform.

TABLE 1
Water Composition

| | |
|---|---|
| Total water hardness (Mg/L) | 165 |
| Calcium:Magnesium ratio | 3:1 |
| pH | 7.7 |
| Volume de-ionized water (L) | 1 |
| Magnesium chloride hexahydrate (Mg/L) | 50 |
| Calcium chloride dihydrate (Mg/L) | 115 |
| Sodium bicarbonate (Mg/L) | 85 |

TABLE 2
Examples 7-14: Liquid Laundry Detergent Compositions Suitable
for Front Loading Automatic Washing Machines.

| | Composition (wt % of composition) | | | | | | | |
|---|---|---|---|---|---|---|---|---|
| | Example Number | | | | | | | |
| Ingredient | 7 | 8 | 9 | 10 | 11 | 12 | 13 | 14 |
| alkylbenzene sulfonic acid | 7 | 11 | 4.5 | 1.2 | 1.5 | 16.3 | 5.2 | 4 |
| sodium C₁₂₋₁₄ alkyl ethoxy 3-sulfate | 2.3 | 3.5 | 4.5 | 4.5 | 7 | 15 | 1.8 | 2 |
| C₁₄₋₁₅ alkyl 7-ethoxylate | 5 | 8 | 2.5 | 2.6 | 4.5 | 4 | 3.7 | 2 |
| C₁₂ alkyl dimethyl amine oxide | — | — | 0.2 | — | — | — | — | — |
| C₁₂₋₁₄ alkyl hydroxyethyl dimethyl ammonium | — | — | — | 0.5 | — | — | — | — |
| chloride | | | | | | | | |
| C₁₂₋₁₈ Fatty acid | 2.6 | 4 | 4 | 2.6 | 2.8 | 7.2 | 2.6 | 1.5 |
| citric acid | 2.6 | 3 | 1.5 | 2 | 2.5 | 4.1 | 2.6 | 2 |
| protease (Purafect Prime ® - 40.6 mg/g active) | 0.5 | 0.7 | 0.6 | 0.3 | 0.5 | 2 | 0.5 | 0.6 |
| amylase (Natalase ® - 29.26 mg/g active) | 0.1 | 0.2 | 0.15 | — | 0.05 | 0.5 | 0.1 | 0.2 |
| mannanase (Mannaway ®- 25.0 mg/g active) | 0.05 | 0.1 | 0.05 | — | — | 0.1 | 0.04 | — |
| random graft co-polymer¹ | 1 | 0.2 | 1 | 0.4 | 0.5 | 0.3 | 0.3 | 1 |
| A compound having the following general | 0.4 | 2 | 0.4 | 0.2 | 1.5 | 0.2 | 0.7 | 0.3 |
| structure: bis((C₂H₅O)(C₂H₄O)n)(CH₃)—N⁺— | | | | | | | | |
| CₓH₂ₓ—N⁺—(CH₃)-bis((C₂H₅O)(C₂H₄O)n), | | | | | | | | |
| wherein n = from 20 to 30, and x = from 3 to 8, | | | | | | | | |
| or sulphated or sulphonated variants thereof | | | | | | | | |
| ethoxylated hexamethylene diamine dimethyl | — | — | — | 0.4 | — | — | — | — |
| quat | | | | | | | | |
| ethoxylated polyethylenimine² | — | — | — | — | — | 3 | — | — |
| amphiphilic alkoxylated grease cleaning | 0.1 | 0.2 | 0.1 | 0.2 | 0.3 | 0.3 | 0.2 | 0.3 |
| polymer³ | | | | | | | | |
| ethoxylated poly (1,2 propylene terephthalate | — | — | — | — | — | — | 0.3 | — |
| short block soil release polymer. | | | | | | | | |
| diethylenetriaminepenta(methylenephosphonic) | 0.2 | 0.3 | — | — | 0.2 | — | 0.2 | 0.3 |
| acid | | | | | | | | |
| hydroxyethane diphosphonic acid | — | — | 0.45 | — | — | 1.6 | — | 0.1 |
| FWA (fluorescent whitening agent) | 0.1 | 0.2 | 0.1 | — | — | 0.2 | 0.05 | 0.1 |
| solvents (1,2 propanediol, ethanol), stabilizers | 3 | 4 | 1.5 | 1.5 | 2 | 1.9 | 2 | 1.5 |
| hydrogenated castor oil derivative structurant | 0.4 | 0.4 | 0.3 | 0.1 | 0.3 | — | 0.4 | 0.5 |
| boric acid | 1.5 | 2.5 | 2 | 1.5 | 1.5 | 0.5 | 1.5 | 1.5 |
| Na formate | — | — | — | 1 | — | — | — | — |
| sodium cumene sulphonate | — | 1.5 | — | — | — | 2.0 | 1.0 | — |
| benefit agent delivery particle* | — | 2.0 | 1.0 | 2.0 | 0.05 | 4.0 | 0.8 | 1.2 |
| reversible protease inhibitor⁴ | — | — | 0.002 | — | — | — | — | — |
| Perfume | 0.5 | 0.7 | 0.5 | 0.5 | 0.8 | 1.7 | 0.5 | 0.8 |
| perfume microcapsules slurry (30% active | 0.2 | 0.3 | 0.7 | 0.2 | 0.05 | — | 0.9 | 0.7 |
| content) | | | | | | | | |
| ethoxylated thiophene Hueing Dye | | | | | | | 0.007 | 0.008 |

| | |
|---|---|
| buffers (sodium hydroxide, | To pH 8.2 |
| monoethanolamine) | |
| Water and optional minors (antifoam, | To 100% |
| aesthetics) | |

TABLE 3
Examples 15-23: Liquid Laundry Detergent Compositions Suitable for Top-Loading Automatic Washing Machines.

| | Composition (wt % of composition) | | | | | | | | |
|---|---|---|---|---|---|---|---|---|---|
| | Example Number | | | | | | | | |
| Ingredient | 15 | 16 | 17 | 18 | 19 | 20 | 21 | 22 | 23 |
| C₁₂₋₁₅ alkylethoxy(1.8) sulfate | 21.0 | 20.0 | 17.5 | 20.0 | 15.1 | 13.7 | 16.7 | 10.0 | 9.9 |
| C_{11.8} alkylbenzene sulfonate | 2.7 | 2.7 | — | 1.0 | 2.0 | 5.5 | 5.6 | 3.0 | 3.9 |
| C₁₆₋₁₇ branched alkyl sulfate | 6.5 | 6.5 | 2.1 | | 4.9 | 3.0 | 9.0 | 2.0 | |
| C₁₂₋₁₄ alkyl -9-ethoxylate | 0.8 | 0.8 | 0.8 | 0.8 | 0.8 | 8.0 | 1.5 | 0.3 | 11.5 |
| C₁₂ dimethylamine oxide | — | — | — | 0.9 | — | — | — | — | |
| citric acid | 3.8 | 3.8 | 3.8 | 3.8 | 3.8 | 3.5 | 3.5 | 2.0 | 2.1 |
| amine oxide | — | — | 0.72 | — | — | — | — | — | |
| C₁₂₋₁₈ fatty acid | 2.0 | 2.0 | 1.8 | 2.0 | 1.5 | 4.5 | 2.3 | — | 0.9 |
| protease (Purafect Prime ® - | 2.0 | — | — | 0.67 | 2.01 | 1.34 | 2.41 | 0.67 | 0.67 |
| 40.6 mg/g active) | | | | | | | | | |
| amylase (Natalase ® - 29.26 | — | 0.3 | — | 0.3 | 0.3 | 0.2 | 0.4 | — | — |
| mg/g active) | | | | | | | | | |
| amylase (Stainzyme ® - 12.0 | — | — | — | — | — | — | — | — | 1.1 |
| mg/g active) | | | | | | | | | |
| mannanase (Mannaway ®- 25.0 | 0.1 | 0.1 | — | — | — | — | 0.1 | — | — |
| mg/g active) | | | | | | | | | |
| pectate lyase (Pectawash ® -20 | 0.1 | 0.1 | — | — | — | — | 0.2 | — | — |
| mg/g active) | | | | | | | | | |
| calcium formate | 0.1 | 0.1 | 0.1 | 0.1 | 0.1 | 0.1 | 0.1 | 0.1 | 0.1 |
| benefit agent delivery particle* | 1.0 | 3.0 | — | — | 0.5 | 2.0 | 5.0 | 0.1 | 0.5 |
| A compound having the | 1.6 | 1.6 | 1.3 | 3.0 | 1.6 | 2.0 | 1.6 | 1.3 | 1.2 |
| following general structure: | | | | | | | | | |
| bis((C₂H₅O)(C₂H₄O)n)(CH₃)— | | | | | | | | | |
| N⁺—CₓH₂ₓ—N⁺—(CH₃)- | | | | | | | | | |
| bis((C₂H₅O)(C₂H₄O)n), | | | | | | | | | |
| wherein n = from 20 to 30, and | | | | | | | | | |
| x = from 3 to 8, or sulphated or | | | | | | | | | |
| sulphonated variants thereof | | | | | | | | | |
| random graft co-polymer¹ | 0.6 | 0.6 | — | 1.0 | 0.5 | 0.6 | 1.0 | 0.8 | 1.0 |
| diethylene triamine pentaacetic | 0.4 | 0.4 | 0.4 | 0.4 | 0.4 | 0.2 | 0.3 | 0.8 | — |
| acid | | | | | | | | | |
| Tinopal AMS-GX | — | — | — | 0.2 | 0.2 | 0.2 | 0.3 | 0.1 | |
| Tinopal CBS-X | — | — | — | — | — | — | 0.1 | — | 0.2 |
| amphiphilic alkoxylated grease | 1.0 | 1.0 | | 1.3 | 1.4 | 1.0 | 1.1 | 1.0 | 1.0 |
| cleaning polymer³ | | | | | | | | | |
| Texcare 240N (Clariant) | — | — | — | — | 1.0 | — | — | — | — |
| ethanol | 2.6 | 2.6 | 2.4 | 2.6 | 2.6 | 1.8 | 3.0 | 1.3 | — |
| propylene glycol | 4.6 | 4.6 | 3.6 | 4.6 | 4.6 | 3.0 | 4.0 | 2.5 | — |
| diethylene glycol | 3.0 | 3.0 | 1.3 | 3.0 | 3.0 | 3.0 | 2.7 | 3.6 | — |
| polyethylene glycol | 0.2 | 0.2 | 0.1 | 0.2 | 0.2 | 0.1 | 0.3 | 0.1 | 1.4 |
| Monoethanolamine | 2.7 | 2.7 | 1.8 | 2.7 | 2.7 | 4.7 | 3.3 | 1.7 | 0.4 |
| Triethanolamine | — | — | — | — | — | — | — | — | 0.9 |
| NaOH | to pH 8.3 | to pH 8.3 | to pH 8.3 | to pH 8.3 | to pH 8.3 | to pH 8.3 | to pH 8.3 | to pH 8.3 | to pH 8.5 |
| sodium cumeme sulphonate | 2.0 | — | — | — | — | — | — | — | — |
| dye | 0.01 | 0.01 | 0.01 | 0.01 | — | 0.01 | 0.01 | 0.01 | 0.0 |
| perfume | 0.5 | 0.5 | — | 0.5 | 0.5 | 0.7 | 0.7 | 0.8 | 0.6 |
| perfume microcapsules slurry | 0.2 | 0.5 | — | 0.2 | 0.3 | 0.1 | 0.3 | 0.9 | 1.0 |
| (30% Active Material) | | | | | | | | | |
| ethoxylated thiophene hueing | — | — | — | — | — | 0.002 | 0.004 | — | — |
| dye | | | | | | | | | |

| | |
|---|---|
| Water | Balance |

TABLE 4
Examples 24-26: Liquid Laundry Detergent Compositions Comprising a Pouch. The
following compositions are encapsulated by a film of polyvinyl alcohol.

| | Composition | | |
|---|---|---|---|
| Ingredient | (Wt % of composition) | | |
| Example Number | 24 | 25 | 26 |
| Linear alkylbenzene sulfonate | 21.0 | 21.0 | 15.0 |
| AES C₁₄₋₁₅ alkyl-7-ethoxylate | 18.0 | 18.0 | 15.0 |
| AES C₁₂₋₁₅ alkylethoxy (3.0) sulphate | — | — | 9.0 |
| C₁₂₋₁₈ Fatty acid | 15.0 | 15.0 | 15.0 |
| Protease (Purafect Prime ®-40.6 mg/g active) | 1.5 | 1.5 | 1.5 |
| Amylase (Natalase ®-29.26 mg/g active) | 0.2 | 0.2 | 0.2 |
| Mannanase (Mannaway ®-25.0 mg/g active) | 0.1 | 0.1 | 0.1 |
| A compound having the following general structure: | 2.0 | 2.0 | 4.0 |
| bis((C₂H₅O)(C₂H₄O)n)(CH₃)—N⁺—CₓH₂ₓ—N⁺—(CH₃)— | | | |
| bis((C₂H₅O)(C₂H₄O)n), wherein n = from 20 to 30, | | | |
| and x = from 3 to 8, or sulphated or sulphonated | | | |
| variants thereof | | | |
| ethoxylated polyethylenimine² | 0.8 | 0.8 | 0.8 |
| hydroxyethane diphosphonic acid | 0.8 | 0.8 | 1.2 |
| FWA | 0.2 | 0.2 | 0.2 |
| solvents (1,2 propanediol, ethanol), stabilizers | 15.0 | 15.0 | 25.0 |
| hydrogenated castor oil derivative structurant | 0.1 | 0.1 | 0.1 |
| reversible protease inhibitor⁴ | — | 0.002 | — |
| benefit agent delivery particle* | 1.0 | 3.0 | 3.0 |
| Perfume | 1.6 | 1.6 | 1.6 |
| ethoxylated thiophene hueing dye | 0.004 | 0.004 | 0.004 |
| buffers (sodium hydroxide, monoethanolamine) | To pH 8.2 | To pH 8.2 | To pH 8.2 |
| water and optional minors (antifoam, aesthetics) | To 100% | To 100% | To 100% |

*Refers to benefit agent delivery particle made according to Examples 2 or 3 herein, wherein the benefit agent is selected from the group comprising Lipex ®, Celluclean ®, Purafect Prime ® metalloproteases described in WO07/044993A2, Stainzyme ®, Stainzyme Plus ®, Liquanase ®, Savinase ®, Natalase ®, Mannaway ® and Pectaway ® or mixtures thereof;
¹As described in U.S. Pat. No. 4,597,898;
²Available under the tradename LUTENSIT ® from BASF and such as those described in U.S. Pat. No. 6,673,890;
³Amphiphilic alkoxylated grease cleaning polymer is a polyethylenimine (MW = 600) with 24 ethoxylate groups per —NH and 16 propoxylate groups per —NH;
⁴Reversible

Protease inhibitor having the structure:

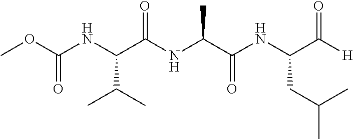

TABLE 5
Examples 27-31: Automatic Dish Washing Detergent Compositions

| | Composition (Wt % of Composition) | | | | |
|---|---|---|---|---|---|
| | Example Number | | | | |
| Ingredient | 27 | 28 | 29 | 30 | 31 |
| Wetting agent¹ | 1.0 | 1.3 | 0.8 | 1 | 0.9 |
| Sodium Benzoate (33% active) | 0.61 | 0.61 | 0.61 | 0.6 | 0.6 |
| Xanthan gum | 1.0 | 0.8 | 1.2 | 1 | 1.1 |
| Sodium Sulphate | 10.0 | 10.0 | 10.0 | 8 | 10 |
| Perfume | 0.03 | 0.05 | 0.03 | 0.06 | 0.1 |
| Sodium Silicate | 0 | 0 | 0 | 0 | 2 |
| Citric Acid (50% active) | 12.5 | 14 | 11 | 12 | 12 |
| Savinase Ultra XL(44 mg active/g)² | 0.7 | 0 | 0.3 | 0 | 0 |
| 4-Formyl-Phenyl Boronic Acid | 0 | 0 | 0.05 | 0 | 0 |
| benefit agent delivery particle* | 0.0 | 2.0 | 2.0 | 2.0 | 3.0 |
| FN3 liquid (48 mg active/g)³ | 0.0 | 0.0 | 0 | 0.6 | 0 |
| Protease Prill (123 mg active/g)³ | 0 | 0 | 0 | 0 | 0.5 |
| Reversible Protease Inhibitor⁴ | 0.0 | 0.0 | 0 | 0.0025 | 0 |
| Ethanol | 0.0 | 0.0 | 0 | 0.3 | 0 |
| Potassium Hydroxide (45% active) | 14.6 | 14.6 | 14.6 | 14 | 0 |
| Calcium Chloride (25% active) | 1.8 | 1.8 | 1.8 | 1.1 | 0.4 |
| Dye | 0.05 | 0.05 | 0.05 | 0.05 | 0.02 |
| Proxcel GXL ™ (19% active)⁷ | 0.05 | 0.05 | 0.05 | 0.05 | 0.05 |
| Acusol ™ 820⁹ | 0.34 | 0.34 | 0.3 | 0.35 | 0.3 |
| Acusol ™ 425N (50% active)⁸ | 3.0 | 3.0 | 3.5 | 2.5 | 2 |
| Termamyl Ultra ® (25 mg/g active)² | 0.2 | 0 | 0 | 0 | 0.1 |
| Stainzyme Plus ® (12 mg/g active)² | 0 | 0.3 | 0.2 | 0 | 0.2 |
| Natalase ® (29 mg/g active)² | 0 | 0 | 0 | 0.2 | 0 |
| Water & other adjunct ingredients | Balance | Balance | Balance | Balance | Balance |
| | to 100% | to 100% | to 100% | to 100% | to 100% |

*Refers to benefit agent delivery particle wherein the benefit agent is any one of Lipex ®, Celluclean ®, Purafect Prime ®, metalloproteases described in US 2008/0293610 A1, Stainzyme ®, Stainzyme Plus ®, Liquanase ®, Savinase ®, Natalase ®, Mannaway ® and Pectaway ® or mixtures thereof;
¹Sold under tradename Polytergent ® SLF-18 by BASF, Ludwigshafen, Germany;
²Sold by Novozymes A/S, Denmark;
³Sold by Genencor International, California, USA. Suitable protease prills are sold under the tradenames FN3 ® and Properase ®;
⁴Reversible Protease inhibitor having the structure noted above;
⁵Sold by Alco Chemical, Tennessee, USA;
⁷Sold by Arch Chemicals Incorporated, Smyrna, Georgia, USA^{;}
⁸Sold by Rohm and Haas, Philadelphia, Pennsylvania, USA.

TABLE 6
Examples 32-35: Additional Detergent Compositions

| Ingredient | 2 | | | |
|---|---|---|---|---|
| Example Number | 31 | 33 | 34 | 35 |
| C11.8 linear alkylbenzene | 17.2 | 17.2 | 13.5 | 14.0 |
| sulfonic acid | | | | |
| Neodol 23-5 | | | 5.2 | |
| Neodol 23-9 | 10.4 | 10.4 | 5.2 | 8.4 |
| Citric acid | 5.0 | 5.0 | 4.5 | 4.1 |
| DTPA¹ | 0.3 | 0.3 | 0.2 | 0.2 |
| Ethanolamine | 3.3 | 3.3 | 2.6 | 2.6 |
| Sodium hydroxide | 0.6 | to adjust | to adjust | to adjust |
| | | pH | pH | pH |
| ethoxylated amine polymer | 2.0 | 2.0 | 1.6 | 1.6 |
| Ethanol | 2.0 | 2.0 | 2.0 | 2.0 |
| silicone suds suppressor | 0.04 | 0.04 | 0.03 | 0.03 |
| Tinopal CBS-X | 0.2 | 0.2 | 0.2 | 0.2 |
| Perfume | 0.3 | 0.3 | 0.2 | 0.2 |
| Blue EM² | 0.005 | — | — | — |
| Basic Violet 3 (CI 42555)³ | — | 0.005 | | — |
| Basic Violet 4 (CI 42600)⁴ | — | | 0.001 | — |
| Acid Blue 7 (CI 42080)⁵ | — | 0.0003 | | — |
| Thickener | 0.1-0.5 | 0.1-0.5 | 0.1-0.5 | 0.1-0.5 |
| neat pH (of composition) | 3.2 | 3.2 | 2.5 | 2.7 |
| reserve acidity⁶ | 2.5 | 2.5 | 2.9 | 2.5 |
| benefit agent delivery | 0.03 | 0.05 | 0.08 | 0.10 |
| particle of Example 3 or 4⁷ | | | | |
| Additional optional minors | 0.1 | 0.1 | 0.1 | 0.1 |

| | |
|---|---|
| Water | Balance |

*Refers to benefit agent delivery particle wherein the benefit agent is selected from the group consisting of Lipex ®, Celluclean ®, Purafect Prime ®, metalloproteases described in US 2008/0293610 A1, Stainzyme ®, Stainzyme Plus ®, Liquanase ®, Savinase ®, Natalase ®, Mannaway ® and Pectaway ® and mixtures thereof; Amphiphilic alkoxylated grease cleaning polymer is a polyethylenimine (MW = 600) with 24 ethoxylate groups per —NH and 16 propoxylate groups per —NH;.
¹diethyleneetriaminepentaacetic acid sodium salt;
²polymeric colorant from Milliken;
^{3, 4}fabric hueing dyes;
⁵non-fabric substantive dye;
⁶g NaOH/100 g of product;
⁷added as fine powder.

The materials described above can be obtained as follows: Linear alkylbenzenesulfonate having an average aliphatic carbon chain length C₁₁-C₁₂ (Stepan, Northfield, Ill., USA); C₁₂₋₁₄ dimethylhydroxyethyl ammonium chloride (Clariant GmbH, Sulzbach, Germany); AE3S is C₁₂₋₁₅ alkyl ethoxy (3) sulfate (Stepan, Northfield, Ill., USA); AE3S is C₁₂₋₁₅ alkyl ethoxy (2) sulfate (Stepan, Northfield, Ill., USA); AE7 is C₁₂₋₁₅ alcohol ethoxylate, with an average degree of ethoxylation of 7 (Huntsman, Salt Lake City, Utah, USA); 1.6R Silicate (Koma, Nestemica, Czech Republic); Sodium Carbonate (Solvay, Houston, Tex., USA); Polyacrylate MW 4500 (BASF, Ludwigshafen, Germany); Carboxy Methyl Cellulose (Finnfix® BDA, available from CPKelco, Arnhem, Netherlands); Savinase®, Natalase®, Lipex®, Duramyl®, Stainzyme®, Termamyl®, Mannaway® (Novozymes, Bagsvaerd, Denmark); Fluorescent Brightener 1 is Tinopal® AMS, Fluorescent Brightener 2 is Tinopal® CBS-X, Sulphonated zinc phthalocyanine and Direct Violet 9 is Pergasol® Violet BN-Z (all available from Ciba Specialty Chemicals, Basel, Switzerland); Diethylenetriamine pentacetic acid (Dow Chemical, Midland, Mich., USA); S-ACMC is carboxymethylcellulose conjugated with C.I. Reactive Blue 19, (Megazyme, Wicklow, Ireland sold under the product name AZO-CM-CELLULOSE, product code S-ACMC); Soil release agent is Repel-o-tex® PF(Rhodia, Paris, France); Acrylic Acid/Maleic Acid Copolymer is molecular weight 70,000 and acrylate:maleate ratio 70:30 (BASF, Ludwigshafen, Germany); Protease is FN3 (Genencor International, Palo Alto, Calif., USA); Sodium salt of Ethylenediamine-N,N′-disuccinic acid, (S,S) isomer (EDDS) (Octel, Ellesmere Port, UK); Hydroxyethane di phosphonate (HEDP) (Dow Chemical, Midland, Mich., USA); Suds suppressor agglomerate is available from Dow Corning, Midland, Mich., USA; HSAS is mid-branched alkyl sulfate as disclosed in U.S. Pat. Nos. 6,020,303 and 6,060,443; C₁₂₋₁₄ dimethyl Amine Oxide (Procter & Gamble Chemicals, Cincinnati, Ohio, USA); Nonionic may comprise a C14-C15 ethoxylate, with an average degree of ethoxylation of 7 or a C₁₂-C₁₃ ethoxylate, with an average degree of ethoxylation of 9; Protease is available from Genencor International, Palo Alto, Calif., USA; Liquitint® Violet CT is available from Milliken, Spartanburg, S.C., USA.; Monosol M8630 film is available from Chris-Craft Industrial Products; C₁₄AO is tetradecyl dimethyl amine oxide.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising;
a. a benefit agent delivery particle comprising a benefit agent and a cellulosic polymer selected from the group consisting of hydroxypropyl methylcellulose phthalate, cellulose acetate phthalate, and mixtures thereof; and
b. one or more adjunct ingredients selected from the group consisting of dye transfer inhibiting agents, brighteners, bleaching agents, photobleaches, clay soil removal/anti-redeposition agents, soil release polymers, soil suspension polymers, suds suppressors, perfumes, fabric softeners, hueing agents, chelating agents, and combinations thereof;
wherein the cleaning composition is a liquid.

2. The cleaning composition of claim 1 wherein the benefit agent comprises a material selected from the group consisting of enzymes, hueing dyes, metal catalysts, bleach catalysts, peracids, perfumes, biopolymers, chelating agent, and mixtures thereof.

3. The cleaning composition of claim 1 wherein the benefit agent comprises an enzyme.

4. The cleaning composition of claim 3 wherein said enzyme is selected from the group consisting of peroxidases, proteases, lipases, phospholipases, cellobiohydrolases, cellobiose dehydrogenases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, and mixtures thereof.

5. The cleaning composition of claim 3 wherein the composition comprises an enzyme stabilizer component selected from the group consisting of:
a. inorganic salts selected from the group consisting of calcium salts, magnesium salts and mixtures thereof;
b. carbohydrates selected from the group consisting of oligosaccharides, polysaccharides and mixtures thereof;
c. mass efficient reversible protease inhibitors selected from the group consisting of phenyl boronic acid and derivatives thereof; and
d. mixtures thereof.

6. The cleaning composition of claim 1 wherein the benefit agent comprises a bleach or bleach catalyst selected from the group consisting of preformed peracids, bleach activators, catalytic metal complexes, non-metal bleach catalyst and mixtures thereof

7. The cleaning composition of claim 1 wherein the benefit agent comprises a bleach booster.

8. The cleaning composition of claim 1 wherein the benefit agent comprises a melamine formaldehyde polymer and at least one perfume ingredient, said melamine formaldehyde polymer encapsulating said perfume ingredient.

9. The cleaning composition of claim 1, wherein the benefit agent comprises a hueing dye.

10. The composition according to claim 1 wherein the benefit agent comprises a fabric softening active, a deposition agent, cationic polymer or cationic starch, or mixtures thereof.

11. The cleaning composition of claim 1 wherein the benefit agent delivery particle has a particle size of from about 0.1 microns to about 1000 microns.

12. The cleaning composition of claim 1 wherein the benefit agent supplied by the benefit agent delivery particles is from about 0.0001 wt % to about 10 wt % of the composition.

13. The cleaning composition of claim 1, wherein from about 50% to about 100% of the benefit agent is released from the benefit agent delivery particles within about ten minutes upon dilution in water as set out in Test Method 1.

14. The cleaning composition of claim 1, wherein from about 60% to about 100% of the benefit agent is present within the benefit agent delivery particle after three weeks at Warm Storage conditions as described in Test Method 2.

15. The cleaning composition of claim 1, wherein the cleaning composition comprises more than one benefit agent delivery particle, wherein the more than one benefit agent delivery particles have different release properties.

16. The cleaning composition of claim 1 wherein the difference between the specific density of the benefit agent delivery particles and the specific density of the cleaning composition in the absence of the benefit agent delivery particles is from about 0 to about 0.5 g/cm³.

17. The cleaning composition of claim 1, wherein the composition comprises a structurant selected from the group consisting of diglycerides and triglycerides, ethylene glycol distearate, microcrystalline cellulose, cellulose-based materials, microfiber cellulose, biopolymers, xanthan gum, gellan gum, and mixtures thereof.

18. A composition according to claim 1, wherein the composition comprises a hydrotrope.

19. The cleaning composition of claim 1, wherein the composition comprises less than about 70% water.

20. The cleaning composition of claim 1, wherein, the benefit agent delivery particle comprises from about 0.5% to about 90% benefit agent based on total dry benefit agent delivery particle weight.

21. A method of imparting a benefit delivery capability to a fabric cleaning composition comprising combining a particle comprising a benefit agent and a polymer selected from the group consisting of hydroxypropyl methylcellulose phthalate, cellulose acetate phthalate, and mixtures thereof with the cleaning composition.

22. The method of claim 21 wherein said benefit agent is selected from the group consisting of enzymes, hueing dyes, metal catalysts, bleach catalysts, peracids, perfumes, biopolymers, and mixtures thereof.

23. The method of claim 21 wherein said particle is combined with at least one component of said cleaning composition and said combination of particle and at least one component of said fabric cleaning composition is combined with other materials to form a cleaning composition.

24. An article comprising a cleaning composition of claim 1 and a water soluble film.

25. A method of treating a situs comprising contacting the situs with the cleaning composition of claim 1.
